(19) United States
(12) Patent Application Publication
(10) Pub. No.: US 2003/0229705 A1
(43) Pub. Date: Dec. 11, 2003

(54) Computer networking system, method of document retrieval in document management system, document management program and media for document management

(76) Inventor: Matsuno Yohichiroh, Tokyo (JP)

Correspondence Address: DICKSTEIN SHAPIRO MORIN & OSHINSKY LLP, 2101 L STREET NW, WASHINGTON, DC, 20037-1526, US

(21) Appl. No.: 10/446,709

(22) Filed: May 29, 2003

(30) Foreign Application Priority Data
May 31, 2002 (JP) 2002-159770

(51) Int. Cl. G06F 15/16

(52) U.S. Cl. 709/229

(57) ABSTRACT

A document management apparatus includes a client terminal, and two document management servers communicatively connected on a network. The client terminal includes a communication mechanism for communicating with the two document management servers, a request issuing mechanism for issuing a replication request to a document management server where the desired document resides for replicating a specific document stored in a document management server to another server. The document management server where the desired document resides is provided with a communication mechanism, a storing mechanism for storing a plurality of documents and a certificate issuing mechanism for issuing to the client terminal a certificate ticket. The document management server that requests a document is provided with a communication mechanism and a storing means for storing specific document.

### FIELD OF THE INVENTION

The present invention relates to a method and system for a document management in which documents are retrieved directly between servers upon a request of a user, i.e. a client, across a network in a distributed computing environment. The present invention also relates to a program and a medium which performs a retrieval of a document from a document management server to another document management server.

### BACKGROUND OF THE INVENTION

With a rapid development in the field of information technology in recent years, various types of general-purpose computer systems including workstations and personal computers have been developed and produced. These computer systems are widely disseminated and the products are also used in research organizations such as universities, offices in companies and families. A variety of digital resources is retrieved in the computer system in the form of text files, voice data files and image data files, and so forth. Recently, a majority of computers and various kinds of devices have been connected to be used in a network environment, including but not limited to the computer system connected, for example, to a local area network (LAN), a wide area network (WAN) and on an Internet adopting TCP/IP protocol under the distributed computing environment.

In the environment mentioned above, when a user defined herein as an individual interacting with a system via a terminal or an application running on a system desires to print a document stored in a document management server on a remote printer, the user is granted an access privilege to print a document desired to print. Then, the user downloads the document file that the user wants to print to the local system and sends the file data to a remote print server for printing.

However, some users may desire to print a document on a remote printer or print server but does not desire to first retrieve and store the document at the user's own local computer system. Some reasons for this may include one or more of the following: the client system may not be in a secure environment; there may be network traffic considerations as well as the billing considerations. It is considered undesirable, therefore, to store files on a local system, even temporarily. In this case, files may be retrieved not via the local system but directly from a file management server to a print server. When a user desires to retrieve print data from a print server in which the files are granted and protected by an access privilege, the print server is required to demonstrate that it has the same access privilege as the user.

Hitherto, Japanese Laid-Open Unexamined Patent Application Publication No.3218017 describes a system for a document management and the related procedure in which when the user accesses a file server on a network from a local system, a certificate (hereinafter referred to as a certificate ticket) is sent to a client by a file server user and subsequently passed on to a remote printer. The certificate demonstrates the remote printer is granted an access privilege. When a user accesses a document stored in a document server from a local system, the file server issues to a local system a certificate ticket that guarantees an access privilege acquired by a user. Then, the local system sends the certificate ticket to the print server. By guaranteeing an access privilege to the document that a user desires to print, the print server obtains a document that the user desires to print from the file server, and the printing job is carried out without storing the data onto a local system.

However, the above-described document management system has a difficulty in retrieving and storing a document in a document management server into another document management server because a sufficient consideration has not been paid to document retrieval between a document management server where the document resides and another document management server that requests the document. Such a scenario is not known to be possible under existing document management systems.

### SUMMARY OF THE INVENTION

In view of the foregoing, it is an object of the present invention to provide a novel document management apparatus which performs a replication of a document from a document management server to another document management server across a network.

Another object of the present invention is to provide a novel document management method which performs a replication of a document from a document management server to another document management server across the network. Another object of the present invention is to provide a novel computer-readable program for a document management program which performs a replication of a document from a document management server to another document management server across a network.

Another object of the present invention is to provide a novel computer-readable media having stored thereon computer-executable instructions which when executed performs a replication of a document from a document management server to another document management server across a network.

To achieve the above-mentioned these and other objects, a novel document management apparatus includes a client terminal, and two document management servers communicatively connected on a network. The client terminal includes a communication mechanism for communicating with the two document management servers, a request issuing mechanism for issuing a replication request to the document management server where the desired document resides. The document management server where the desired document resides is provided with a communication mechanism, a storing mechanism for storing a plurality of documents and a certificate issuing mechanism for issuing to the client server a certificate ticket. The document management server that requests a document is provided with a communication mechanism and a storing mechanism for storing a specific document.

The client terminal may cause the document management server where the target document resides to issue the replication request issued by the request issuing mechanism. The document management server where the target document resides causes the certificate issuing mechanism to issue the certificate ticket. The client terminal receives the certificate ticket and sends the certificate ticket to the document management server that requests the document. The document management server that requests the document receives the certificate ticket and sends the certificate ticket to the document management server where the target document resides. The document management server where the target document resides transfers the specific document to the document management server that requests the document using the certificate ticket to store the specific document.

Further, to achieve these and other objects, in one embodiment, a novel document management method includes the steps of issuing a replication request from a client terminal, issuing a certificate ticket from the document management server where the document resides, transferring the certificate ticket to the document management server where the document resides and transferring the specific document to the document management server that requests the document.

When two or more documents are requested for replication, the certificate ticket may be provided with information for allowing the document management server where the target document resides to replicate the requested two or more documents and the requested documents are transferred in response to the certificate ticket for the two or more documents.

When a part of a document or documents is requested for replication, the certificate may be provided with information for allowing the document management server where the target document resides to replicate the requested part of the document, and a part of the document requested is transferred in response to the certificate ticket for the target document.

When attributes of documents are requested, the certificate ticket may be provided with information for allowing the document management server where the target document resides to replicate the attributes of documents, and the attributes of documents are transferred in response to the certificate ticket for the attributes of documents.

When a document or a part of a document whose format is converted is requested for replication, the certificate ticket may be provided with information for allowing the second server to replicate the document or part of the document whose format is converted and the document or part of the document whose format is converted is then transferred in response to the certificate ticket for the document or part of the document whose format is converted.

The certificate ticket may be provided with information for allowing the client terminal to certify that the client terminal is granted a manipulation privilege to a requested document, and a document designated by the certificate is then transferred from the first server to the second server ticket after confirming that the certificate ticket includes information certifying the validity of the manipulation privilege to the requested document.

The certificate ticket may also be provided with a digital signature of the document management server where the target document resides, and from the first server to the second server a document designated by the certificate ticket is transferred after confirming that the certificate ticket includes the digital signature of the first server.

The certificate ticket may also be provided with a validity date of the certificate ticket.

To achieve the above-mentioned objects, a computer-readable program for a document management is embodied on an information storage medium, having processing routines executed by a computer system. In one embodiment, a novel document management apparatus includes the steps of issuing a replication request from a client terminal, issuing a certificate ticket from the document management server where the document resides, transferring the certificate ticket to the document management server where the document resides and transferring the specific document to the document management server that requests the document.

Further, to achieve these and other objects, a novel computer-readable medium is provided. In one embodiment, the computer-readable medium includes the steps of issuing a replication request from a client terminal, issuing a certificate ticket from the document management server where the document resides, transferring the certificate ticket to the document management server where the document resides and transferring the specific document to the document management server that requests the document.

Other objects, features and advantages of the present invention will become apparent from the following detailed description when read in conjunction with the accompanying drawings.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a schematic diagram showing an exemplary document management system according to a preferred embodiment of the present invention;

FIG. 2 is a block diagram showing an exemplary structure of computers used in the document management system of FIG. 1;

FIG. 3 is an illustration showing a certificate ticket of the document management system of FIG. 1;

FIG. 4 is a flowchart showing an exemplary procedure of the document management system of FIG. 1;

FIG. 5 is an illustration showing communications of computers during the procedure of FIG.1;

FIG. 6 is an illustration showing another certificate ticket of the document management system of FIG. 1;

FIG. 7 is a flowchart showing another exemplary procedure of the document management system of FIG. 1;

FIG. 8 is an illustration showing another certificate ticket of the document management system of FIG. 1;

FIG. 9 is a flowchart showing another exemplary procedure of the document management system of FIG. 1;

FIG. 10 is an illustration showing another certificate ticket of the document management system of FIG. 1;

FIG. 11 is a flowchart showing another exemplary procedure of the document management system of FIG. 1;

FIG. 12 is another illustration showing a certificate ticket of the document management system of FIG. 1; and

FIG. 13 is another flowchart showing an exemplary procedure of the document management system of FIG. 1.

### DETAILED DESCRIPTION OF PREFERRED EMBODIMENTS

This application is based on Japanese Patent application JPAP2002-159770 filed in the Japanese Patent Office on May 31, 2002. The entire content of the application is hereby incorporated by reference.

In describing preferred embodiments of the present invention illustrated in the drawings, specific terminology is employed for the sake of clarity. However, the present invention is not intended to be limited to the specific terminology so selected and it is understood that specific elements include all technical equivalents which operate in a similar manner.

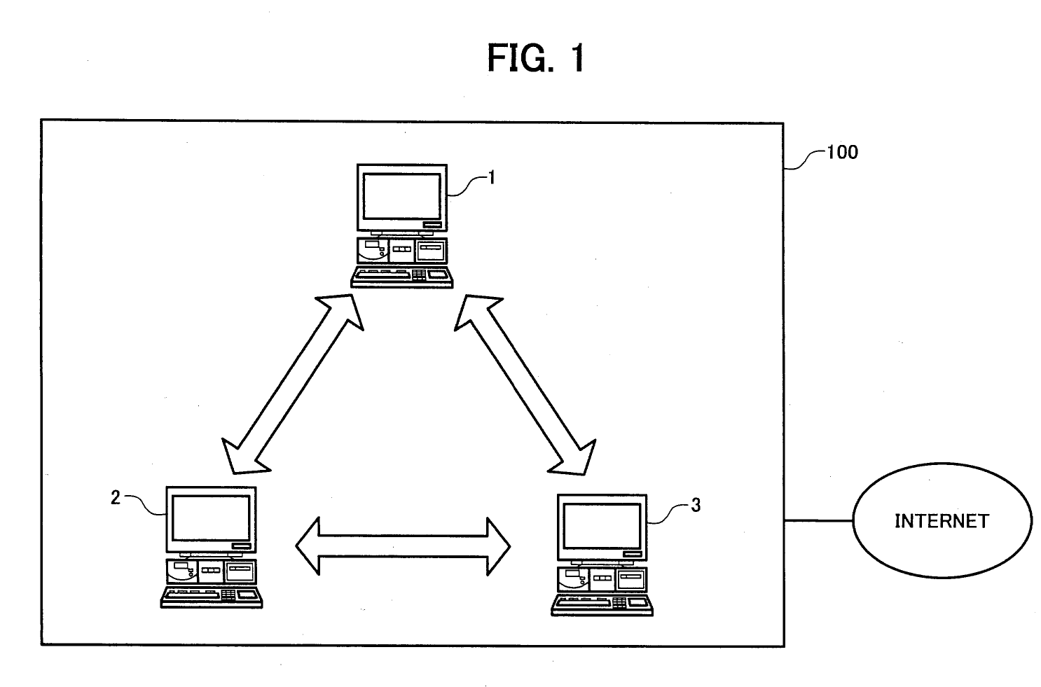

Referring now to the drawings, wherein like reference numerals designate identical or,corresponding parts throughout the several views and more particularly to FIG. 1 thereof, a document management system 100 is shown.

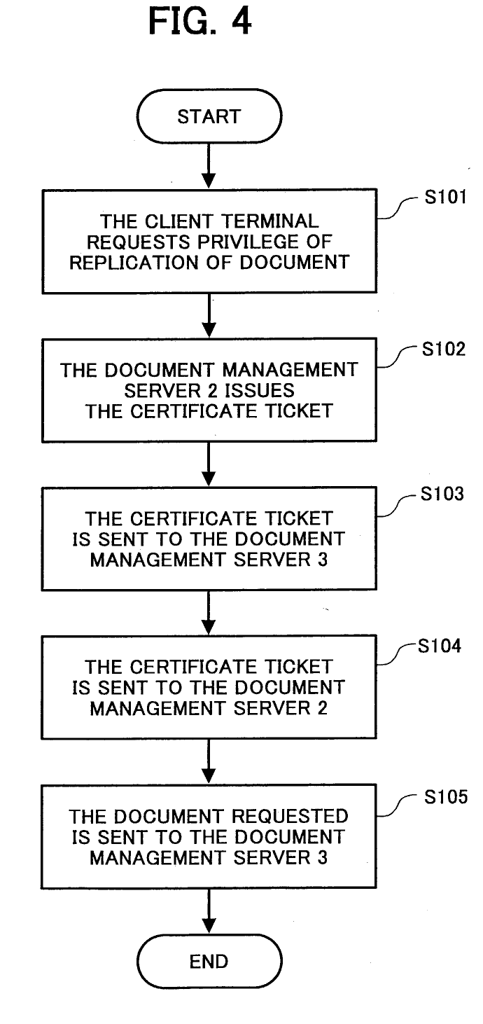

In FIG. 1, the document management system 100 includes a client terminal 1, a document management server 2 and a document management server 3. These apparatuses are connected across a network. The document management system 100 performs a document management operation which is explained below with reference to FIG. 4.

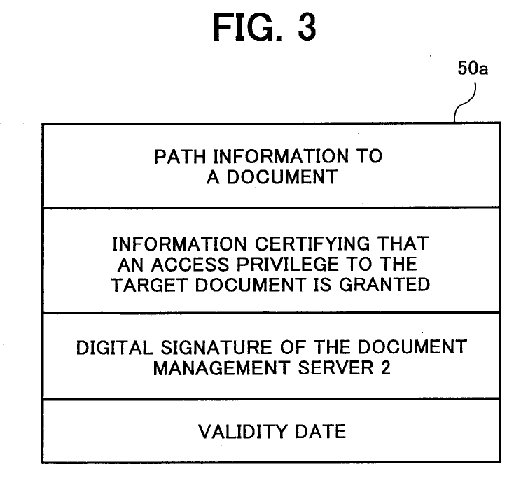

The client terminal 1 requests a privilege of manipulation such as document search, data backup and replication, for example, to the document management servers 2 and 3, and performs various operations. The client terminal 1 receives a certificate ticket 50a (See FIG. 3) to guarantee an access privilege and exercises the privilege in the document management operation. The document management servers 2 and 3 store and manage target documents in their database in response to a request by the client terminal 1 for searches, data backup and replication. The document files may include content information or data containing attribute information.

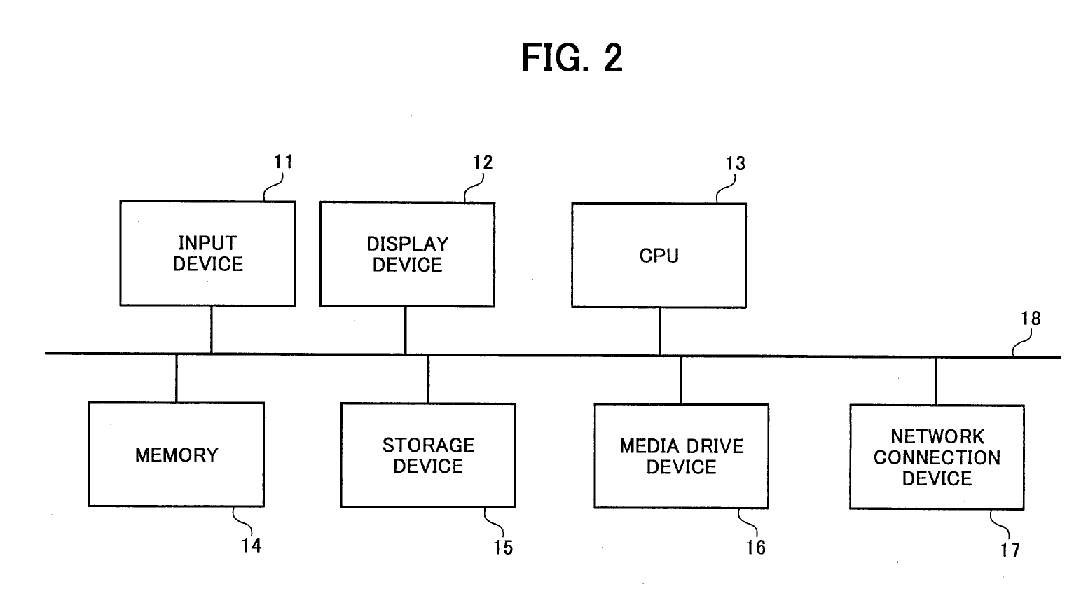

The document management servers 2 and 3 issue the certificate ticket 50a that serves as an access privilege to information including information that is needed for executing a request upon receiving a request from the client terminal 1, for example, data backup, document search and replication. Each of the client terminal 1 and the document management servers 2 and 3 include components as shown in FIG. 2.

As shown in FIG. 2, the client terminal 1 includes an input device 11, a display device 12, a central processing unit (a CPU) 13, a memory 14, a storage device 15, a media drive device 16, a network connection device 17, an internal bus 18, hard disk (not shown) and removable disk (not shown).

The CPU 13 controls client terminal 1. The memory 14 includes semiconductor memories such as a read-only memory (ROM) and a random-access memory (RAM). The memory 14 temporarily stores the control program of the CPU 13 for document management operation and information associated with the document management procedure and storing information created through the document management operation. The storage device 15 stores a document management program for executing document management operation and an information file created upon execution of the document management program. The storage device 15 also stores a certificate ticket 50a in FIG. 3 issued upon a request from the client 1 for data backup, document search and replication to the document management servers 1 and 2. The input device 11, for example a keyboard, a mouse, a touch panel and a scanner, is used for inputting information for issuing a request to the document management servers 2 and 3. The display device 12 includes a cathode-ray tube (CRT) and a liquid crystal display (LCD) or the like used to display output information such as the information and search result entered through the input device 11. The media drive device 16 reads specific media for read data thereon and stores the read data into the memory 14 or storage media 15. The network connection device 17 interfaces the document management servers 2 and 3 as well as the client terminal 1. Signals and data are exchanged through the network connection device 17 between the document management servers 2 and 3 and the client terminal 1. The internal bus 18 connects the above-described devices.

FIG. 2 is a block diagram of the structure of the computer network of the client terminal 1. An identical structure of the computer network is applied to the structure of the document management servers 2 and 3, respectively.

As shown in FIG. 2, the document management servers 2 and 3, respectively, include an input device 11, a display device 12, a CPU 13, a memory 14, a storage device 15, a media drive device 16, a network connection device 17, an internal bus 18, hard disk (not shown) and removable disk (not shown).

In the document management servers 2 and 3, the CPU 13 controls the entire structure of the document management servers 2 and 3, respectively, and the CPU 13 of the document management server 2 and 3 carries out the document management function in the embodiment including the function of issuing the certificate ticket 50a to the client terminal 1. The memory 14 includes semiconductor memories such as a read-only memory (ROM) and a random-access memory (RAM). The memory 14 temporarily stores the control program of the CPU 13 for the document management operation and information associated with the document management procedure and storing information created through the document management operation.

The storage device 15 stores a document management program for executing document management operation and also an information file created upon execution of the document management program. The input device 11 is used for inputting information associated with the document management operation such as information for a keyboard, mouse, touch panel and scanner. The display device 12 includes a cathode-ray tube (CRT) or a liquid crystal display (LCD) or the like used to display output in connection with the document management operation entered through the input device 11. The media drive device 16 reads specific media for read data thereon and stores the read data into the memory 14 and the storage media 15. The network connection device 17 interfaces the document management servers 2 and 3 with the client terminal 1. Signals and data are exchanged through the network connection device 17 between the document management servers 2 and 3 and the client terminal 1. The internal bus 18 connects the above-described devices.

The above-described network is used in the document management system 100 that connects the client terminal 1 and the document management servers 2 and 3 via cables and accords with TCP/IP as a network protocol. However, based on a premise that the network protocols are identical between the connecting parties, as an alternative, different networks can be used including, but not limited to: a hard-wired/cabled communications network, local area network (LAN), wide area network (WAN), Internet, telephone/modem-based network communications, integrated services digital network (ISDN), public communications network (PCN), mobile network system/communications links, satellite communications network, and so forth.

The recording media used in the embodiment include semiconductor media such as a read-only memory (ROM), an IC memory card, an optical media such as a CD-ROM, a digital versatile disk (DVD), a magneto-optical disk (MO), a Minidisk (MD) and a rewritable CD-R and so forth and a magnetic media such as a magnetic tape and a floppy disk (FD).

The document management program installed from the above-described recording media into the memory 14 and recording media 15 is the document management program used for running the document management function in the embodiment. The document management program is pre-written into recording media such as a CD-ROM, for example. The CD-ROM is applied to the media drive device 16 such as a CD-ROM drive mounted in the computers in respective locations. These document management programs are stored respectively in the memory 14 and the storage device 15. When the CPU 13 for each client terminal 1 and document management servers 2 and 3 is executed, the document management function described in the embodiment is achieved. When a document management program is pre-stored in semiconductors such as a ROM, for example, the document management program is executed, not from the media drive device 16 but by directly loading from the memory 14.

As described above, in the document management system 100, the CPU of each of the client terminal 1 and the document management servers 2 and 3 performs and executes the document management program so that the document management function is carried out. As an alternative, either all of the actual processing or a part is executed under the operating system based on each of the document management programs in the client terminal 1 and document management servers 2 and 3.

As shown in FIG. 3 the certificate ticket 50a includes various kinds of information including path information such as the certificate to allow access to a file source requested by the client terminal 1, information to certify that a manipulation privilege to the source has been granted to one of the document management servers 2 and 3, for example, the digital signature of the document management servers 2 and 3 and information on the validity date indicating how long the manipulation privilege is valid for the document required. Information demonstrating an access privilege to the target document mentioned above also includes information indicating that the file sources are accessed from one of the document management server 2 and 3. Also, a variety of information is included in the certificate ticket 50a including encrypted user name, passwords and the identity of the document management server. An access privilege to an assigned server is guaranteed in the embodiment by submitting a digital signature of the document management server 2 where a manipulation target document resides. Additionally, an administrator of a company or an organization, for example, may specify date and terms of validity of the access privilege, and the validity date may be input via the manipulation of the input device 11 of the client terminal 1.

Referring to FIG. 4, the document management operation performed by the document management system 100 is explained. The document management operation of FIG. 4 is an exemplary document management operation performed by the document management system 100. In this operation, a document in the document management server 2 is retrieved and stored in the document management server 3 upon a request for replication from the client terminal 1 to the document management server 2. It is possible to perform another operation in which a document is retrieved from the document management server 3 to the document management server 2.

As shown in FIG. 4, in Step S101, a document retrieval program of the document management program instructs the CPUs 13 of the client terminal 1 and document management servers 2 and 3 to perform various operations during document management operation. The document management program also instructs the CPU 13 of the client terminal 1 to request a privilege of replicating a document stored in the document management server 2 to the document management server 3 upon a request of the client terminal 1 to the document management server 2. The document retrieval program in Step S102 tells the CPU of the document management server 2 to issue a certificate ticket 50a (shown in FIG. 3) from the document management server 2 to the client terminal 1 upon a request from the client terminal 1 after the validity of the terminal 1 is confirmed. The certificate ticket 50a includes information needed for obtaining a document file including the document that a client desires to obtain. In Step S103, the certificate ticket 50a received from the document server 2 is sent from the client terminal 1 to the document management server 3. In Step S104, the document management server 3 sends the certificate ticket 50a received from the client terminal 1 to the document management server 3. Based on the information determining whether or not the document management server 3 is granted the access privilege to a specified document, and when the document management server 3 is granted the access privilege for the requested document, the document management server 2 reads the specified document in its database in which the target document is stored. The document management server 2 sends the document to the document management server 3 in Step S105.

As mentioned above, the document management system 100 includes client terminal 1, the document management server 2 and the document management server 3 communicatively connected through the network.

The client terminal 1 includes the network connection device 17 through which the document management servers 2 and 3 communicate with each other across the network. The client terminal 1 also includes the CPU 13 that issues a replication request from the document management server 3 to the document management server 2 and a privilege of replicating a document stored in the document management server 2.

The document management server 2 includes the network connection device 17 through which the client terminal 1 and the document management server 3 communicate with each other, the storage device 15 to store a plurality of documents including contents of information and attribute information, and a CPU to instruct the document management server 2 to issue the certificate ticket 50a to the client terminal 1 including information needed for replicating to the document management server 3 the document stored in the storage device 15 in the document management server 2. The document management server 3 includes the network connection device 17 through which the client terminal 1 and the document management server 2 communicate with each other and the storage device 15 to store a plurality of documents containing contents of information or attribute information.

The client terminal 1 sends the above-mentioned replication request issued from the CPU 13 of the client terminal 1 to the document management server 2 through the connection device 17 of the client terminal 1. The document management server 2 sends the client terminal 1 the above-described certificate ticket 50a issued from the CPU of the document management server 2 upon the above-mentioned replication request through the network device 17 of the document management server 2. The client terminal 1 sends the replication request issued from the CPU 13 via the network connection device 17 of the client terminal 1 to the document management server 3. The document management server 3 further sends a replication request issued from the CPU of the document management server 3 via the network connection device 17 of the document management server 3 to the document management server 2 in response to the replication request. The document management server 2 sends the above-mentioned certificate ticket 50a via the network connection device 17 of the document management server 3. The document management server 2 sends the target copy of the document stored in the storage device 15 of the document management server 2 to the document management server 3. The document management server 3 receives the target copy of the document sent from the document management server 2 through the network connection device 17 of the document management server 2. In this way, documents are directly exchanged between the document management server 2 and the document management server 3 without replicating and storing the target copy of the document file in the client terminal 1 because the storage device 15 of the document management server 3 is provided with a replication function, thus preventing network traffic congestion and enhancing network security.

As mentioned above, the network connects the document management server 2 and the document management server 3 that respectively manage and store a plurality of documents including content and attribute information and the client terminal 1 that accesses the document management servers 2 and 3. The document management operation according to FIG. 4 includes the steps of various operations. In Step S101, the client terminal 1 requests a privilege of replication to the document management server 2 to retrieve a document stored in the document management server 2 for the document management server 3. In Step S102, the document management server 2 issues and sends to a client terminal 1 the certificate ticket 50a including information needed for sending the document requested from the client terminal 1. In Step 103, the client terminal 1 sends to the document management server 3 the certificate ticket 50a received from the document management server 2. In Step 104, the document management server 3 sends to the document management server 2 the certificate ticket 50a received from the client terminal 1. In Step 105, the document management server 2 verifies the certificate ticket 50a sent from the client terminal 1 to the document management server 3 and when the certificate ticket 50a is determined as valid, sends to the document management server 3 the target copy of the document.

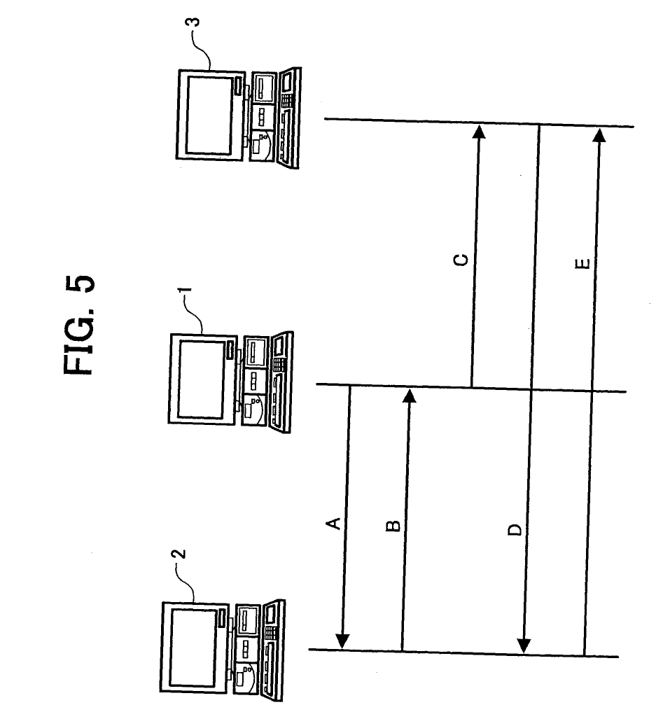

Referring to FIG. 5, the process flow of the document management operation is shown. In the Step A, the client terminal 1 requests a privilege of replication to the document management server 2 to retrieve a document stored in the document management server 2 for the document management server 3. In Step B, the document management server 2 issues and sends to a client terminal 1 the certificate ticket 50a including information needed for sending the document requested from the client terminal 1. In Step C, the client terminal 1 sends to the document management server 3 the certificate ticket 50a received from the document management server 2. In Step D, the document management server 3 sends to the document management server 2 the certificate ticket 50a received from the client terminal 1. In Step E, the document management server 2 verifies the certificate ticket 50a sent from the client terminal 1 to the document management server 3 and when the certificate ticket 50a is determined as valid, sends to the document management server 3 the target copy of the document.

In this way, traffic congestion is prevented and the network is secured. If the document management operation mentioned so far is adopted, the retrieval of the document management program and documents, data backup and distribution of the replication results are carried out.

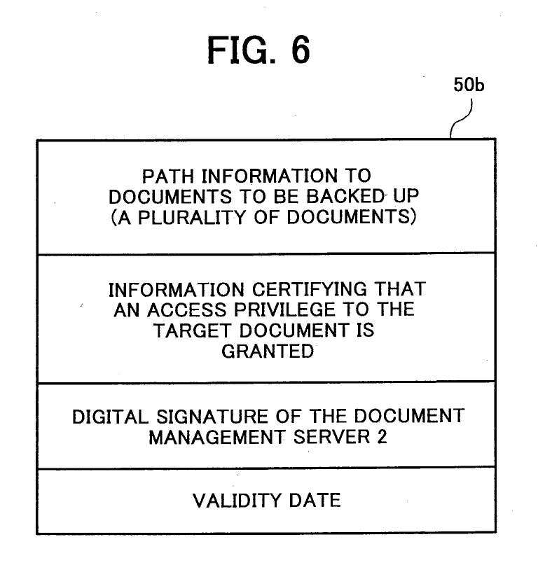

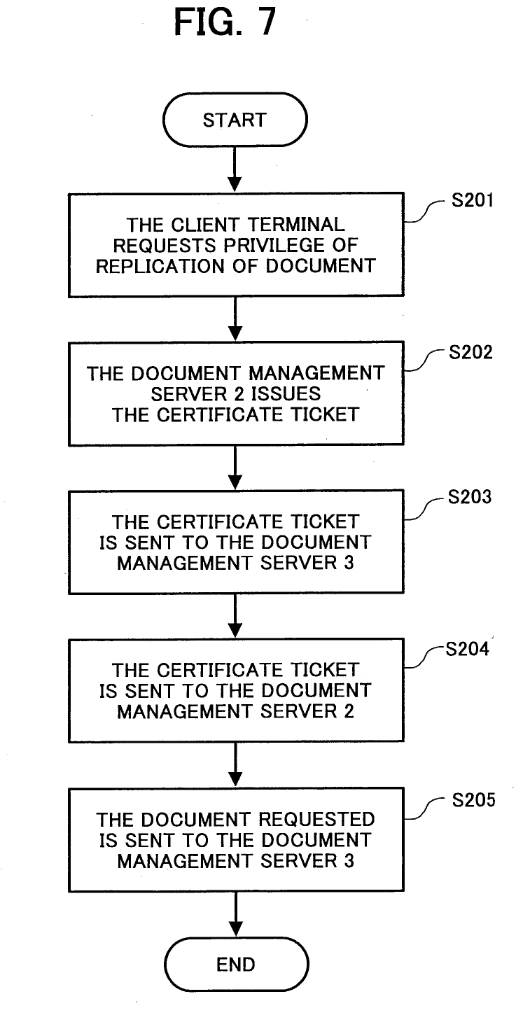

Next, a certificate ticket 50b used in the document management system 100 is explained with reference to FIGS. 6 and 7. The certificate ticket 50b of FIG. 6 is similar to the certificate ticket 50a of FIG. 3, except that a plurality of documents are sent at once from the document management server 2 to the document management server 3 for storage upon a one time manipulation request by the client terminal 1. Traffic congestion can be prevented each time.

As shown in FIG. 6, the certificate ticket 50b includes path information to the document a user at the client terminal 1 desires to back up and information certifying that an access privilege is granted to one of the client terminal 1, the document management servers 2 and 3. The certificate ticket 50b also includes a digital signature granted to the client terminal 1, the document management servers 2 and 3 and a manipulation privilege granted to either the client terminal 1, or the document management servers 2 or 3 certifying the validity of the manipulation privilege. Information on a plurality of target documents the user desires to back up may be contained in the above-described certificate ticket 50b. Also path information certifying the manipulation privilege to the target document is granted includes various kinds of information such as information certifying that access is from one of the document management servers 2 or 3. One kind of information includes an encrypted user name and passwords. Another kind of information includes the identity of the document management server 2 and 3, respectively. An access privilege to an assigned server is guaranteed by submitting a digital signature of the document management server 2 where a manipulation target document resides. Additionally, an administrator of a company or an organization, for example, may specify date and terms of validity of the access privilege and a validity date may be input via the manipulation of the input device 11 of the client terminal 1.

Referring to FIG. 7, the document management program is explained. This document management program embodies a document management procedure explained above. FIG. 7 shows an exemplary procedure in which a plurality of documents in the document management server 2 is sent to the document management server 3 upon a request from the client terminal 1.

A document search program of the document management program is executed in the following steps. In Step S201, the client terminal 1 requests to the CPUs 13 of the document management servers 2 and 3 a privilege to retrieve from the document management server 2 to the document management server 3 and to back up a plurality of target documents in the document management server 3. In Step S202, the document management server 2 issues the certificate ticket 50b shown in FIG. 6 containing information needed for obtaining a document file including the target document. In Step S203, the client terminal 1 sends to the document management server 3 the certificate ticket 50b received from the document management server 2. In Step S204, the document management server 3 sends to the document management server 2 the certificate ticket 50b received from the client terminal 1. In Step S205, in response to the various kinds of information contained in the certificate ticket 50b from the document management server 3, the document management server 2 determines whether or not the certificate ticket 50b contains the access privilege to a specified document in the document management server 2. If the document server 3 does have an access privilege to a specified document, the document management server 2 reads the specified document from its database and sends the document to the document management server 3.

As shown in FIG. 7, the processes from Steps S201 through S205 are executed sequentially. In Steps S202, S203 and S204, the certificate ticket 50b is exchanged, for more detail the certificate ticket 50b is issued from the document management server 2 to the client terminal 1. The certificate ticket 50b received from the document management server 2 is sent to the document management server 3. When a plurality of documents are required to be backed up and when it is determined that resource path information to the target document is contained in the above-mentioned certificate ticket 50b, the document management server 2 sends a plurality of documents to the document management server 3 in succession in Step S205.

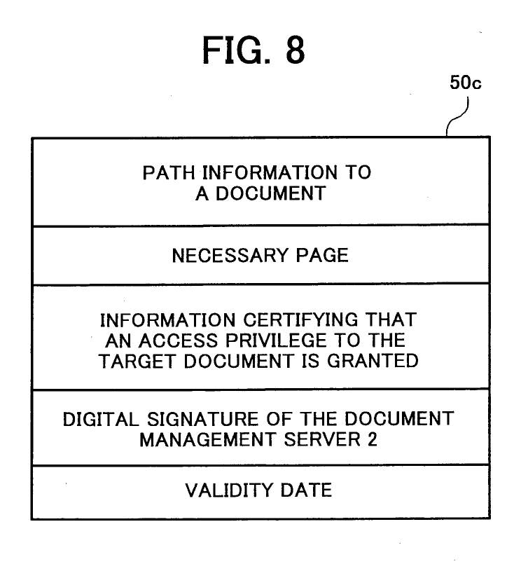

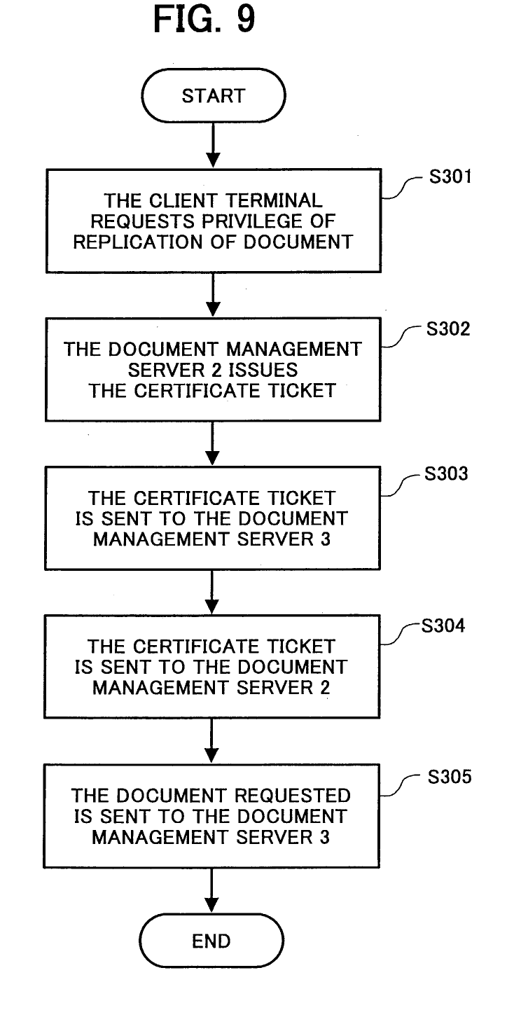

Next, a certificate ticket 50c used in the document management system 100 is explained with reference to FIGS. 8 and 9. The certificate ticket 50c of FIG. 8 is similar to the certificate ticket 50b of FIG. 6 except for the fact that a part of a document and attribute information are exchanged among the client terminal 1, the document management server 2 and the document management server 3 whereas a plurality of documents are sent in the case of the certificate ticket 50b of FIG. 6, upon a request from the client terminal 1. A necessary part of a document may be retrieved, thereby preventing the network traffic from being high.

As shown in FIG. 8, the certificate ticket 50c includes path information on a document that a user at the client terminal 1 desires to back up, information indicating a corresponding page of a document that is necessary when a user desires to back up a part of a document and information certifying that an access privilege is granted to the client terminal 1, or the document management servers 2 or 3. The certificate ticket 50c also includes a digital signature granted to each of the client terminal 1, the document management servers 2 and 3 and a manipulation privilege granted to the client terminal 1, or the document management servers 2 or 3 certifying the manipulation privilege to a part of the page, for example, of document is valid. Also path information certifying the manipulation privilege to the target document granted includes various kinds of information. One kind of information is information certifying that access is from one of the document management servers 2 or 3 and information relating to an encrypted user name and passwords. Other information includes information on a certificate guaranteeing the identity of one of the document management servers 2 and 3. In the embodiment, an access privilege to an assigned server is guaranteed by submitting a digital signature of the document management servers 2 where a manipulation target document resides. Additionally, an administrator of a company or an organization, for example, may specify the date and terms of validity of the access privilege and the validity date may be input via the manipulation of the input device 11 of the client terminal 1.

Referring to FIG. 9, a document management program is explained. The document management program embodies the document management operation shown in FIG. 9. FIG. 9 shows an exemplary procedure in which a document in the document management server 2 is sent to the document management server 3 upon a request from the client terminal 1.

The document search program of the document management program is executed in the following steps. In Step S301, the client terminal 1 requests to the CPUs 13 of the document management servers 2 and 3 a privilege to retrieve from the document management server 2 to the document management server 3 and to back up part of the target documents in the document management server 3. In Step S302, the document management server 2 issues the certificate ticket 50c shown in FIG. 8 containing information needed for obtaining the document file including the target document. In Step S303, the client terminal 1 sends to the document management server 3 the certificate ticket 50c received from the document management server 2. In Step S304, the document management server 3 sends to the document management server 2 the certificate ticket 50c received from the client terminal 1. In Step S305, in response to the various information contained in the certificate ticket 50c from the document management server 3 and when it is determined whether or not the certificate ticket 50c contains the access privilege to a specified document in the document management server 2, for example, the document management server 2 reads the specified document from its database and sends the document to the document management server 3.

As shown in FIG. 9, the processes from Steps S301 through S305 are executed sequentially. In Steps S302, S303 and S304, the certificate ticket is exchanged among the client terminal 1, the document management server 2 and 3. For more detail, the certificate ticket 50c is issued from the document management server 2 to the client terminal 1. The certificate ticket 50c received from the document management server 2 is sent to the document management server 3. When a plurality of documents are required to be backed up and when it is determined that resource path information is contained in the above-mentioned certificate ticket 50c, the document management server 2 sends a plurality of documents to the document management server 3 in succession in Step S305.

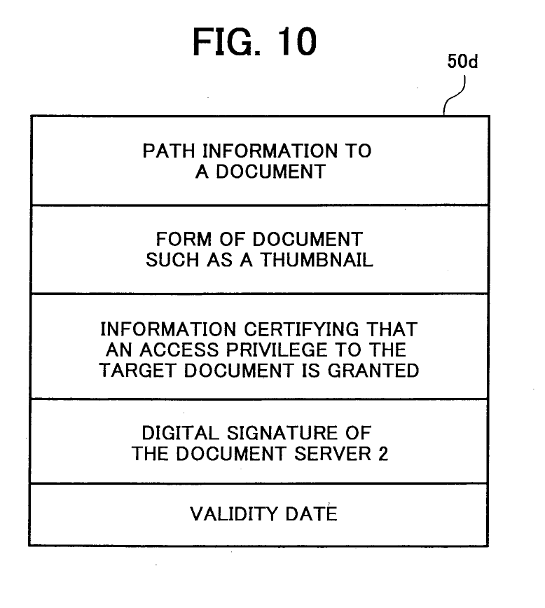

Next, a certificate ticket 50d is used in the document management system 100 is explained with reference to FIG. 10. The certificate ticket 50d of FIG. 10 is similar to the certificate ticket 50c of FIG. 8 except for the fact that the document server 2 sends to the document management server 3 a document in a designated format for a backing up purpose.

As shown in FIG. 10, the certificate ticket 50d includes path information on a target document that a user desires to back up, information on the format of document which designates a format of document in which the user desires to back up such as thumbnail, for example, and information certifying that an access privilege to a designated document is granted to the client terminal 1, or the document management servers 2 or 3. The certificate ticket 50d also includes a digital signature granted to each of the client terminal 1 and the document management servers 2 and 3, and a manipulation privilege granted to a client terminal 1, or the document management servers 2 or 3 certifying the validity of the manipulation privilege.

A document format such as a thumbnail, for example, converts types of character font of a specific image data and an image data into a Portable Document File (PDF) and, in some cases, creates a thumbnail of a document and sends the thumbnail. Also, path information certifying the manipulation privilege to the target document is granted includes information certifying that access is from one of the document management servers 2 and 3 and information on encrypted user name and passwords. Path information certifying the manipulation privilege to the target document is granted also includes a certificate guaranteeing the identity of one of the document management servers 2 and 3. In the embodiment, an access privilege to an assigned server is guaranteed by submitting a digital signature of the document management server where a manipulation target document resides. Additionally, an administrator in a company or an organization, for example, may specify date and terms of validity of the access privilege and a validity date may be input via the manipulation of the input device 11 of the client terminal 1.

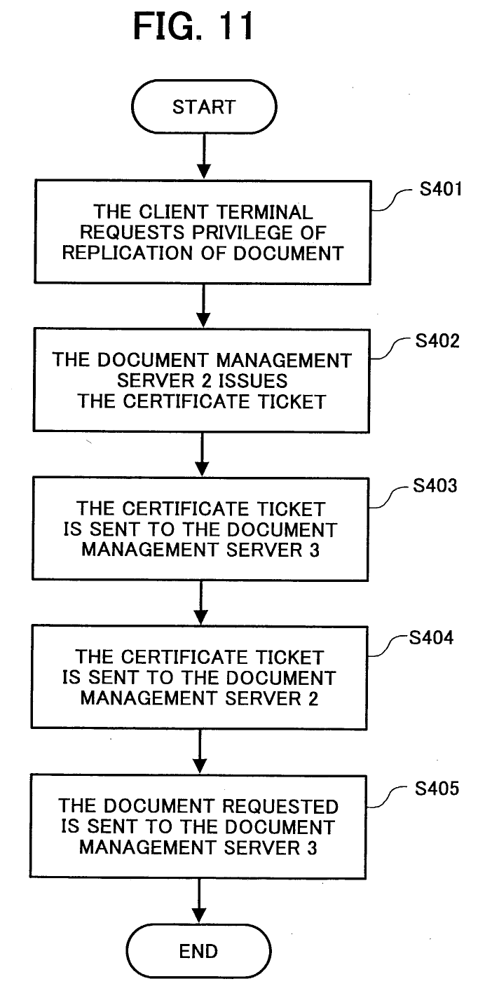

Referring to FIG. 11, a document management program is explained. This document management program embodies the document management procedure shown in FIG. 11. FIG. 11 shows an exemplary procedure in which a document in the document management server 2 is sent to the document management server 3 upon a request from the client terminal 1.

The document search program of the document management program is executed in the following steps. In Step S401, the client terminal 1 requests to the CPUs 13 of the document management servers 2 and 3 a privilege to retrieve from the document management server 2 to the document management server 3 and to back up the target documents in a designated format in the document management server 3. In Step S402, the document management server 2 issues the certificate ticket 50d shown in FIG. 10 containing information needed for obtaining the document file including the target document. In Step S403, the client terminal 1 sends to the document management server 3 the certificate ticket 50d received from the document management server 2. In Step S404, the document management server 3 sends to the document management server 2 the certificate ticket 50d received from the client terminal 1. In Step S405, in response to the various kinds of information contained in the certificate ticket 50d from the document management server 3, for example, information on certifying whether or not the certificate ticket 50d is provided with the access privilege to a designated document in the document management server 2. For example, the document management server 2 reads the designated document from its database and sends the document to the document management server 3 in the designated format.

The processes from Steps S401 through S405 are executed sequentially. In Steps S402, S403 and S404, the certificate ticket 50d is exchanged in such a way that the certificate ticket 50d is issued from the document management server 2 to the client terminal 1. The certificate ticket 50d received from the document management server 2 is sent to the document management server 3. When a designated document is desired to be backed up in a designated format and when it is determined that resource path information is contained in the above-mentioned certificate ticket 50d, the document management server 2 sends the designated document in a designated format to the document management server 3 in succession in Step S405.

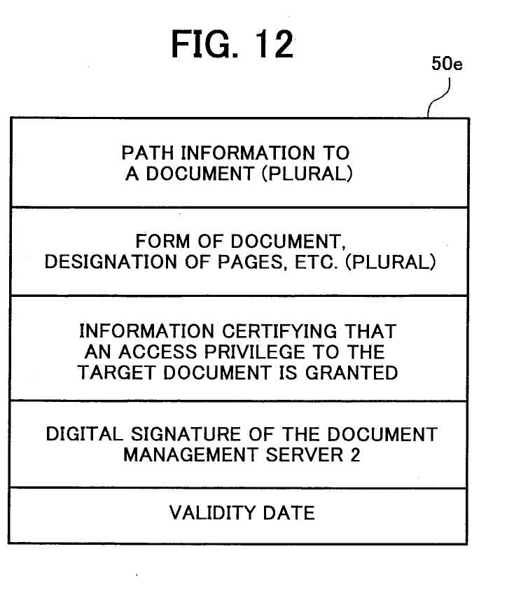

Next, a certificate ticket 50e used in the document management system 100 is explained with reference to FIG. 12. The certificate ticket 50e of FIG. 12 is similar to the certificate 50d of FIG. 10 except for the fact that regarding the certificate ticket 50e, the document server 2 sends a part of two or more documents in a designated format when backing up a part of a designated document. A part of a plurality of documents for a backup use is sent in a designated format from the document management server 2 to the document management server 3. The attribute information of a plurality of documents that is updated may be sent for a backup purpose from the document management server 2 to the document management server 3.

As shown in FIG. 12, the certificate ticket 50e includes path information on a document desired to be backed up by the client terminal 1. Information contained in the certificate ticket 50e includes information on the format of the document, designation of page and designation of attribute information. As above described, the format of a document, designation of page and designation of attribute information of a corresponding page of document may be specified by a user in the certificate ticket 50e. Also included in the certificate ticket 50 is information certifying that an access privilege is granted to the client terminal 1, or the document management servers 2 or 3. The certificate ticket 50e further includes a digital signature granted to each of the client terminal 1, the document management servers 2 and 3 and a validity date certifying a manipulation privilege granted to one of the client terminal 1, the document management servers 2 and 3 is valid.

Information on the format of a document, designation of page and designation of attribute information allow for converting types of character font or image data of a part of a page of a document into a Portable Document File (PDF) or creates a thumbnail of a document and sends the thumbnail with attribute information of the document. Path information of a document to be backed up includes information on specifying a path to a plurality of documents. With information including format of a document provided, designation of page and designation of attribute information, the format of documents of a plurality of documents or the page to be backed up and attribute information of the document that is updated may be specified. For example, when attribute information, such as a title, for example, is updated, it is only the updated attribute information that is specified. Also, path information certifying the manipulation privilege to the target document is granted includes various kinds of information such as information certifying that access is from one of the document management servers 2 or 3 and information on an encrypted user name and passwords. Path information certifying the manipulation privilege to the target document is granted also includes a certificate guaranteeing the identity of the document management server 2 or 3. In this embodiment, an access privilege to an assigned server is guaranteed by submitting a digital signature of the document management server 2 where a manipulation target document resides. Additionally, an administrator of a company or an organization, for example, may specify date and terms of validity of the access privilege and a validity date may be input via the manipulation of the input device 11 of the client terminal 1.

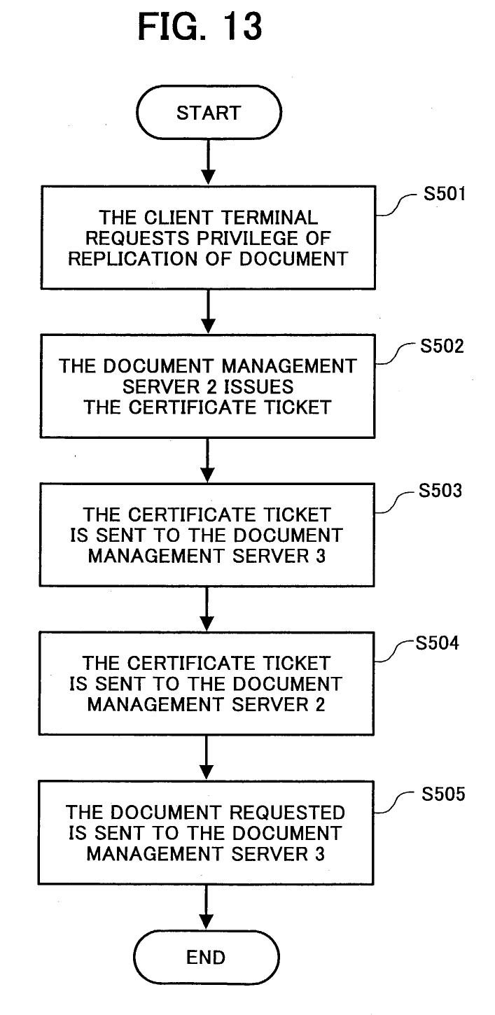

Referring to FIG. 13, a document management program is explained. This document management program embodies the document management procedure of FIG. 13. FIG. 13 shows an exemplary procedure in which a part of the document and attribute information in the document management server 2 is sent to the document management server 3 in a designated format,upon a request from the client terminal 1. This applies to the case where the document management server 3 that has stored the attribute information of a plurality of documents that resides in the document management server 2 and when a part of the document is updated in the document management server 2, a part of the document updated and attribute information of the updated documents may be sent to the document server 3.

The document search program of the document management program is executed in the following steps. In Step S501, the client terminal 1 requests to the CPUs 13 from the document management server 2 a privilege to retrieve from the document management server 2 for the document management server 3 and to back up a part of the target documents and the attribute information in a designated format in the document management server 3. In Step S502, the document management server 2 issues the certificate ticket 50e shown in FIG. 12 containing information needed for obtaining the document file including the target document. In Step S503, the client terminal 1 sends to the document management server 3 the certificate ticket 50e received from the document management server 2. In Step S504, the document management server 3 sends to the document management server 2 the certificate ticket 50e received from the client terminal 1. In Step S505, in response to the various information contained in the certificate ticket 50e from the document management server 3 such as whether or not the certificate ticket 50e contains the access privilege to a designated document in the document management server 2, for example, the document management server 2 reads the designated document from the database and sends the designated page and attribute information including version information in the designated from to the document management server 3.

As mentioned above, in the document management operation, in Step S502, when a part of a plurality of the target documents and attribute information and the above-described document whose part is converted as format of document, designation of page and plural designation of attribute information, for example, is provided to the certificate ticket 50e, a necessary information for obtaining the above-described document whose part is partially converted is provided to the certificate ticket 50e. In S505, because a part of the requested documents, attribute information or a part of the document whose form is partially converted is sent to the document management server 3, the document management server 2, which is merely a reference point, does not always need all the documents in full text. It is only a part of the contents or the document that is sent in the designated form, thereby preventing the traffic from becoming high.

As mentioned above, the embodiment in which the format of documents, pages and attribute information may be specified may also be applied to all other preceding embodiments. In one example, when the last embodiment in which the format of documents, pages and attribute information may be specified is applied to the embodiment in the case where only one document is replicated. In this case, the last embodiment may be applied to the case in a manner in which a document is sent and replicated together with attribute information from the document management server 2 to the document management server 3 with the format of the target document converted to a designated format. In the case of an embodiment which replicates a plurality of documents, the last embodiment may also be applied to replicating a plurality of documents in a manner such that a plurality of documents are replicated together with attribute information after converting the format of the target document into a designated format. When the last embodiment is applied to the embodiment in which the transfer of documents are in the form of a thumbnail, the document converted into a thumbnail is sent from the document management server 2 to the document management server 3 with attribute information attached. When applied to the embodiment in which the transfer of documents is in a designated format, the last embodiment may be applied in a manner such that the target document may be sent and replicated with attribute information to the document management server 3 after converting the document into the designated format, in other words, a necessary page.

This invention may be conveniently implemented using a conventional general-purpose digital computer programmed according to the teachings of the present specification, as will be apparent to those skilled in the computer art. Appropriate software coding can readily be prepared by skilled programmers based on the teachings of the present disclosure, as will be apparent to those skilled in the software art. The present invention may also be implemented by the preparation of application specific integrated circuits or by interconnecting an appropriate network of conventional component circuits, as will be readily apparent to those skilled in the art.

Numerous additional modifications and variations are possible in light of the above teachings. It is therefore to be understood that within the scope of the appended claims, the disclosure of this patent specification may be practiced otherwise than as specifically described herein.

What is claimed as new and desired to be protected by Letters Patent of the United States is:

1. A document management system coupled to a network, comprising:
a first communications apparatus comprising:
a certificate issuing mechanism for issuing a certificate ticket giving authorization to replicate a specific document from said plurality of documents stored by the first storing mechanism;
a second communications apparatus; and
a third communications apparatus comprising:
a request issuing mechanism for issuing a replication request for requesting the first communicating apparatus to issue the certificate ticket when requiring replication of the specific document by the second communications apparatus.

2. The document management system as defined in claim 1, wherein the first, second and third communications apparatuses communicate with one another through the network.

3. The document management system as defined in claim 2, wherein the first communications apparatus sends the certificate ticket to the third communications apparatus in response to the replication request sent from the third communications apparatus.

4. The document management system as defined in claim 3, wherein the third communicating apparatus transfers the certificate ticket to the second communications apparatus after receiving from the first communications apparatus.

5. The document management system as defined in claim 4, wherein the second communications apparatus sends the certificate ticket transferred from the third communications apparatus to the first communications apparatus so that the first communications apparatus transfers the specific document to the second communications apparatus in response to the certificate ticket.

6. The document management system as defined in claim 1 further comprising a first memory connected to said first communications apparatus for storing a plurality of documents.

7. The document management system as defined in claim 1 further comprising a second memory connected to said second communications apparatus for storing a specific document replicated using the certificate ticket.

8. A document management system coupled to a network, comprising:
a first communications apparatus comprising:
a first storing means for storing a plurality of documents; and
a certificate issuing means for issuing a certificate ticket giving authorization to replicate a specific document from said plurality of documents stored by the first storing means;
a second communications apparatus comprising:
a second storing means for storing the specific document replicated using the certificate ticket from said plurality of documents stored in the first storing means; and
a third communications apparatus comprising:
a request issuing means for issuing a replication request for requesting the first communicating apparatus to issue the certificate ticket when requiring replication of the specific document by the second communications apparatus.

9. The document management system as defined in claim 8, wherein the first, second and third communications apparatuses communicate with one another through the network.

10. The document management system as defined in claim 9, wherein the first communications apparatus sends the certificate ticket to the third communications apparatus in response to the replication request sent from the third communications apparatus.

11. The document management system as defined in claim 10, wherein the third communicating apparatus transfers the certificate ticket to the second communications apparatus after receiving from the first communications apparatus.

12. The document management system as defined in claim 11, wherein the second communications apparatus sends the certificate ticket transferred from the third communications apparatus to the first communications apparatus so that the first communications apparatus transfers the specific document to the second communications apparatus in response to the certificate ticket.

13. A document management method comprising the steps of:
first causing a client terminal to issue a replication request to a first server to allow a second server to replicate a specific document from among a plurality of documents stored in the first server;
second causing the first server to issue a certificate ticket to the client terminal in response to the replication request;
third causing the client terminal to transfer the certificate ticket to the second server;
fourth causing the second server to transfer the certificate ticket to the first server; and
fifth causing the first server to transfer the specific document from among the plurality of documents stored in the first server to the second server in response to the certificate ticket transferred from the second server.

14. The document management method as defined in claim 13, wherein when two or more documents are requested for replication, the second causing step provides the certificate with information for allowing the second server to replicate the requested two or more documents and the fifth causing step transfers the requested two or more documents in response to the certificate ticket for the two or more documents.

15. The document management method as defined in claim 13, wherein said certificate includes information for allowing the second server to replicate the specific document from among the plurality of documents

16. The document management method as defined in claim 13, wherein when a part of a document is requested for replication, the second causing step provides the certificate with information for allowing the second server to replicate the requested part of the document and the fifth causing step transfers the part of the document requested in response to the certificate ticket for the part of the document.

17. The document management method as defined in claim 13, wherein when attributes of documents are requested for replication, the second causing step provides the certificate with information for allowing the second server to replicate the attributes of documents and the fifth causing step transfers the attributes of documents requested in response to the certificate ticket for the attributes of documents.

18. The document management method as defined in claim 13, wherein when the document or a part of a document whose format is converted are requested for replication, the second causing step provides the certificate with information for allowing the second server to replicate the document or a part of the documents whose format is converted and the fifth causing step transfers the document or a part of the documents whose format is converted in response to the certificate ticket for the document or a part of the document whose format is converted.

19. The document management method as defined in claim 13, wherein the second causing step provides the certificate with information for allowing the first server to certify that the client terminal is granted with a manipulation privilege to a requested document and the fifth causing step transfers from the first server to the second server a document designated by the certificate ticket after confirming that the certificate ticket includes information certifying the validity of the manipulation privilege to the requested document.

20. The document management method as defined in claim 13, wherein the second causing step provides the certificate with a digital signature of the first server and the fifth causing step transfers from the first server to the second server a document designated by the certificate ticket after confirming that the certificate ticket includes the digital signature of the first server.

21. The document management method as defined in claim 13, wherein the second causing step provides the certificate with a validity date of the certificate ticket.

22. A computer-readable program for a document management embodied on an information storage medium, comprising processing routines executed by a computer system:
a first operation causing a client terminal to issue a replication request to a first server which allows a second server to replicate a specific document from among a plurality of documents stored in the first server;
a second operation causing the first server to issue a certificate ticket to the client terminal in response to the replication request, the certificate including information for allowing the second server to replicate the specific document from among the plurality of documents;
a third operation causing the client terminal to transfer the certificate ticket to the second server;
a fourth operation causing the second server to transfer the certificate ticket to the first server; and
a fifth operation causing the first server to transfer the specific document from among the plurality of documents stored in the first server to the second server in response to the certificate ticket transferred from the second server.

23. The document management program as defined in claim 22, wherein when two or more documents are requested for replication, the second operation provides the certificate with information for allowing the second server to replicate the requested two or more documents and the fifth operation transfers the requested two or more documents in response to the certificate ticket for the two or more documents.

24. The document management program as defined in claim 22, wherein when a part of a document is requested for replication, the second operation provides the certificate with information for allowing the second server to replicate the requested part of the document and the fifth operation transfers the part of the document requested in response to the certificate ticket for a part of the document.

25. The document management program as defined in claim 22, wherein when attributes of documents are requested for replication, the second operation provides the certificate with information for allowing the second server to replicate the attributes of documents and the fifth operation transfers the attributes of documents requested in response to the certificate ticket for the attributes of documents.

26. The document management program as defined in claim 22, wherein when the document or a part of a document whose format is are converted are requested for replication, the second operation provides the certificate with information for allowing the second server to replicate the document or part of the document whose format is converted and the fifth operation transfers the document or part of the document whose format is converted in response to the certificate ticket for the document or part of the document whose format is converted.

27. The document management program as defined in claim 22, wherein the second operation provides the certificate with information for allowing the first server to certify that the client terminal is granted with a manipulation privilege to a requested document and the fifth operation transfers from the first server to the second server a document designated by the certificate ticket after confirming that the certificate ticket includes information certifying the validity of the manipulation privilege to the requested document.

28. The document management program as defined in claim 22, wherein the second operation provides the certificate with a digital signature of the first server and the fifth operation transfers from the first server to the second server a document designated by the certificate ticket after confirming that the certificate ticket includes the digital signature of the first server.

29. The document management program as defined in claim 22, wherein the second operation provides the certificate with a validity date of the certificate ticket.

30. A computer-readable medium having stored thereon computer-executable instructions which when executed perform a document management method, the method comprising the step of:
a first operation causing a client terminal to issue a replication request to a first server to allow a second server to replicate a specific document from among a plurality of documents stored in the first server;
a second operation causing the first server to issue a certificate ticket to the client terminal in response to the replication request, the certificate including information for allowing the second server to replicate the specific document from among the plurality of documents;
a third operation causing the client terminal to transfer the certificate ticket to the second server;
a fourth operation causing the second server to transfer the certificate ticket to transfer the first server; and
a fifth operation causing the first server to transfer the specific document from among the plurality of documents stored in the first server to the second server in response to the certificate ticket transferred from the second server.

31. The document management medium as defined in claim 30, wherein when two or more documents are requested for replication, the second operation provides the certificate with information for allowing the second server to replicate the requested two or more documents and the fifth operation transfers the requested two or more documents in response to the certificate ticket for the two or more documents.

32. The document management medium as defined in claim 30, wherein when a part of a document is requested for replication, the second operation provides the certificate with information for allowing the second server to replicate the requested part of the document whose format is converted and the fifth operation transfers the part of the document requested in response to the certificate ticket for the part of the document.

33. The document management medium as defined in claim 30, wherein when attributes of documents are requested for replication, the second operation provides the certificate with information for allowing the second server to replicate the attributes of documents and the fifth operation transfers the attributes of documents requested in response to the certificate ticket for the attributes of documents.

34. The document management medium as defined in claim 30, wherein when the document or a part of a document whose format is converted are requested for replication, the second operation provides the certificate with information for allowing the second server to replicate the document or a part of the document whose format is converted and the fifth operation transfers the document or a part of the document whose format in response to the certificate ticket for the document or part of the document whose format is converted.

35. The document management medium as defined in claim 30, wherein the second operation provides the certificate with information for allowing the first server to certify the client terminal that the client terminal is granted with a manipulation privilege to a requested document and the fifth operation transfers from the first server to the second server a document designated by the certificate ticket after confirming that the certificate ticket includes information certifying the validity of the manipulation privilege to the requested document.

36. The document management medium as defined in claim 30, wherein the second operation provides the certificate with a digital signature of the first server and the fifth operation transfers from the first server to the second server a document designated by the certificate ticket after confirming that the certificate ticket includes the digital signature of the first server.

37. The document management medium as defined in claim 30, wherein the second operation provides the certificate with a validity date of the certificate ticket.
